(19) United States
(12) Patent Application Publication
(10) Pub. No.: US 2006/0111066 A1
(43) Pub. Date: May 25, 2006

(54) Tuner

(76) Inventor: Gary Thorpe, Wiltshire (GB)

Correspondence Address: ARENT FOX PLLC, 1050 CONNECTICUT AVENUE, N.W., SUITE 400, WASHINGTON, DC, 20036, US

(21) Appl. No.: 11/250,620

(22) Filed: Oct. 17, 2005

(30) Foreign Application Priority Data
Oct. 18, 2004 (GB) 0423079.3

(51) Int. Cl. H04N 5/445; H04B 1/06

(52) U.S. Cl. 455/232.1; 348/731; 725/38

(57) ABSTRACT

A tuner is provided for selecting a channel for reception from a multiple channel input signal. The tuner has a signal path which converts a selected channel, for example in a frequency changer, to a standard intermediate frequency and supplies this to a demodulator. The signal path has at least one controllable variable gain stage. The tuner also comprises a controller which periodically operates the tuner in a channel mapping mode. In this mode, a look-up table is provided by determining from the signal at the input which channels are occupied, together with other data relating to each occupied channel. During the normal reception mode of the tuner, the controller 8 selects a channel for reception and then controls the or each variable gain stage in accordance with the occupancy of channels adjacent the selected channel.

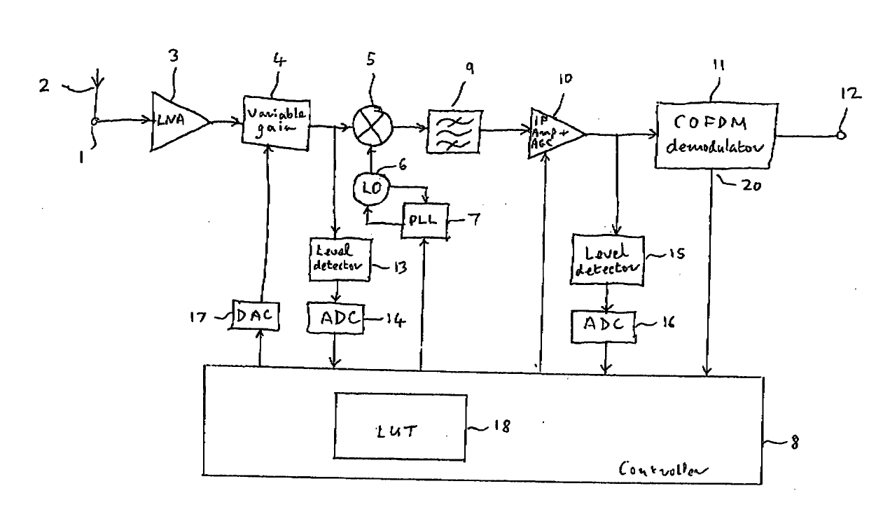

### TECHNICAL FIELD

The present invention relates to a tuner for selecting a channel for reception from a multiple channel input signal. For example, such a tuner may be used for receiving signals from a terrestrial broadcast-receiving aerial or from a satellite aerial system or may be used for receiving signals distributed by a cable network. For example, the tuner may be used for digital terrestrial television signals modulated according to the COFDM (Coded Orthogonal Frequency Division Multiplex) standard.

### BACKGROUND

In known types of tuner, for example for receiving digital terrestrial television signals, a conventional aerial is arranged to receive broadcasts from one or more remote transmitters. The channels occupied by the received signals depend on which transmitters are in range of the aerial and which services are provided by such transmitters. Signal levels depend on local reception conditions, mainly on the distance from the transmitter or transmitters serving that area

Tuners generally have front ends including level control circuits which adjust the signal level according to an intermediate frequency target level which is predetermined. Thus, when receiving a selected wanted channel, the level control circuits may not make any allowances for the presence of signals in adjacent channels which can potentially interfere with reception. Such adjacent channel signals may be of lower or higher levels that the that the selected wanted channel and this may result in overload within the front end and/or signal level setting to the wrong level.

### SUMMARY

According to the invention, there is provided a tuner for selecting a channel for reception from a multiple channel input signal, comprising: a signal path arranged to select a channel and to convert the selected channel to a format suitable for demodulation, the signal path including at least one controllable variable gain stage; and a controller having a reception mode and a channel mapping mode, the controller being arranged, in the mapping mode, to provide a look-up table of channel occupancy in the input signal and, in the reception mode, to control the gain of the at least one variable gain stage in accordance with the occupancy, from the table, of at least one channel adjacent the selected channel.

The tuner way be arranged, in the mapping mode, to create or update the table from the input signal.

The controller may be arranged to perform the mapping mode each time the tuner is powered up.

The controller may be arranged to perform the mapping mode during a stand-by mode of the tuner.

The controller may be arranged to perform the mapping mode periodically while the tuner is powered up.

Each entry in the table may comprise the channel number and an indication of whether the channel is occupied by a signal. The entry in the table for each occupied channel may contain an indication of whether the signal is analogue or digital.

The entry in the table for each occupied channel may contain an indication of the signal power.

The entry in the table for each occupied channel may contain an indication of signal/noise ratio.

Each entry in the table may contain an indication of any frequency offset from the nominal channel frequency.

Each entry in the table for each occupied channel may contain an indication of whether the adjacent higher and/or lower channel is occupied. The entry in the table for each occupied channel with at least one occupied adjacent channel may contain at least part of the entry for the or each occupied adjacent channel.

The signal path may comprise at least one frequency changer for converting the selected channel to an intermediate frequency. The at least one variable gain stage may comprise a first variable gain stage ahead of the or every frequency changer. The controller maybe arranged to reduce the gain of the first variable gain stage when the at least one adjacent channel is occupied.

The at least one variable gain stage may comprise a second intermediate frequency variable gain stage forming part of an automatic gain control arrangement. The controller may be arranged to reduce a target level of the automatic gain control arrangement when the at least one adjacent channel is occupied.

The controller may be arranged, in the mapping mode, to scan the tuner through the channels in the input signal and to determine the channel occupancy on the basis of received signal level.

The controller may be arranged, in the mapping mode, to scan the tuner through the channels in the input signal and to determine channel occupancy by a digital signal on the basis of the presence of TPS (Transmission Parameter Signalling) data.

It is thus possible to provide a tuner which contains information on the channel occupancy of a received multiple channel input signal and which can adapt to the channel occupancy in order to provide improved reception. For example, level control circuitry in the tuner can be adapted to take into account the presence of occupied adjacent channels so as to avoid overloading front end stages while maintaining an acceptable signal/noise ratio. By scanning the input signal to determine which channels are currently occupied, adequate performance can be achieved for the prevailing reception conditions. Such an arrangement is particularly, but not exclusively, useful for digital terrestrial reception where the input signal may contain an arbitrary selection of analogue and digital signals of arbitrary and varying levels. Thus, a digital terrestrial tuner can be provided which effectively adapts to the prevailing reception conditions at any location and with any aerial arrangement.

### BRIEF DESCRIPTION OF THE DRAWINGS

The accompanying single FIGURE is a block schematic diagram of a tuner constituting an embodiment of the invention.

### DETAILED DESCRIPTION

The tuner has an input 1, which is connected to a terrestrial broadcast reception aerial 2 but which could also be used for reception with a cable distribution system or a satellite broadcast aerial system. The tuner is illustrated as being of the single conversion type but this is purely exemplary and the present techniques may be applied to any suitable type of tuner.

The tuner has a “front end” comprising a low noise amplifier (LNA) 3 connected via a variable gain stage 4 to a mixer 5 of the frequency changer. The frequency changer further comprises a local oscillator (LO) 6 controlled by a phase locked loop (PLL) synthesiser 7. The synthesiser 7 is controlled by a controller 8, for example based on a programmed microcomputer.

The frequency changer comprising the mixer 5, the local oscillator 6 and the synthesiser 7 converts any desired selected channel for reception to an intermediate frequency in the well-known way. The intermediate frequency output signal of the mixer 5 is supplied to a bandpass filter 9 which passes the selected channel at the intermediate frequency and attenuates other channels. The output of the filter 9 is supplied to an intermediate frequency (IF) amplifier and automatic gain control (AGC) stage 10. The output of the stage 10 is supplied to a coded offset frequency division multiplex (COFDM) demodulator 11, which demodulates the selected channel and supplies the demodulated signal to an output 12.

The output of the variable gain stage 4 is also supplied to a level detector 13 which detects the level of the signal supplied to the mixer 5. The detected level is supplied to an analogue/digital converter (ADC) 14, whose output is supplied to the controller 8.

The output of the stage 10 is supplied to a level detector 15 which detects the level of the signal, principally the selected channel, supplied to the modulator 11. The detected level is supplied to an ADC 16, whose output is supplied to the controller 8.

The controller supplies an output signal to a digital/analogue converter (DAC) 17, whose output is connected to a gain controlling input of the variable gain stage 4. The controller 8 thus controls the gain of the stage 4. The controller 8 has another output connected to the stage 10. This output supplies a target level to the stage 10 for use in the AGC arrangement. In particular, the AGC arrangement of the stage 10 compares the actual signal level at the input of this stage with the target level and adjusts the gain of the stage 10 so that the output signal level is equal to or nearer to the target level.

The controller 8 contains a look-up table (LUT) 18 for storing a map of the channels in the input signal supplied to the input 1 of the tuner. The LUT 18 may be created each time the tuner is powered up, in which case it need not be stored in non-volatile memory. Alternatively, the LUT may be repeatedly updated and may be stored in non-volatile memory.

The controller 8 operates the tuner in a “mapping mode” in order to create or update the LUT 18. The mapping mode may be performed each time the tuner is powered up and may be performed periodically while the tuner is powered up in order to maintain the LUT 18 up-to-date. However, the mapping mode may be performed alternatively or additionally at other times, for example periodically while the tuner is in a stand-by mode so as to not delay or interrupt reception when the tuner is powered up.

During the mapping mode, the tuner causes the PLL synthesiser 7 to step the tuner through all of the channel frequencies of the input signal while detecting the presence or absence of a signal at the currently selected channel frequency, whether the signal is analogue or digital the power level, any frequency offset from the nominal channel frequency, and the signal/noise ratio. The presence or absence of a signal within the currently selected channel may be determined from the signal level detected by the detector 15 and supplied to the controller 8 via the ADC 16. The power level of the signal can be inferred from this detected level and from the gain of the stages 4 and 10. Alternatively, if the tuner includes tracking filtering between the input 1 and the level detector 13, the RF power level can be inferred from the level detected by the detector 13 and supplied via the ADC 14 to the tuner 8. The demodulator 11 has an output 20 which supplies a signal indicative of whether the currently received channel contains TPS data. This signal may therefore be used to indicate the presence of a digital signal in the currently selected channel.

The controller 8 may form a channel map of the type shown in the following table.

| | | | Type | | | | | | | | | | | | | | |
|---|---|---|---|---|---|---|---|---|---|---|---|---|---|---|---|---|---|
| | | | A | | A | D | D | A | D | | A | D | A | D | D | | |
| Ref. | | | C5 | | C4 | D2 | D5 | C1 | D1 | | C3 | D3 | C2 | D4 | D6 | | |
| No. | 21 | . . . | 37 | . . . | 54 | 55 | 56 | 58 | 59 | . . . | 61 | 62 | 64 | 65 | 67 | . . . | 69 |
| Offset | | | | | | + | + | | + | | | + | | + | | | |

This channel map is typical of that which may be obtained within the UK and relates to the Mendip television transmitter, The “Type” row indicates whether the received channel is analogue (A) or digital (D), the “Ref” gives the conventional nomenclature for the actual channel (C1 is BBC1, C2 is BBC2, etc.), “No.” is the channel number and “Offset” indicates the presence of a positive (+), negative (−), or zero ( ) offset of 166 kHz relative to the nominal channel frequency.

The controller derives from this channel map the look-up table and an example based on the above channel map is as follows:

| Channel | Wanted channel | | | | Adjacent channel interferers | | | |
|---|---|---|---|---|---|---|---|---|
| No. | Type | \hat{ } | S/N | <> | [symbol] | \hat{ } | → | \hat{ } |
| 37 | A | 50 | — | 0 | — | | — | |
| 54 | A | 35 | — | | | | D | |
| 55 | D | 50 | 21 | + | A | 35 | D | 55 |
| 56 | D | 55 | 22 | + | D | 50 | — | |
| 58 | A | 40 | — | 0 | — | | D | 55 |
| 59 | D | 55 | 21 | + | A | 40 | — | |
| 61 | A | 35 | — | 0 | — | | D | 60 |
| 62 | D | 60 | 21 | + | A | 35 | — | |
| 64 | A | 40 | — | 0 | — | | D | 55 |
| 65 | D | 55 | 22 | + | A | 40 | — | |
| 67 | D | 50 | 25 | 0 | — | | — | |

Key:
\hat{ }= power level in dBm [symbol]
= lower adjacent channel
→ = upper channel
S/N = signal to noise ratio
<> = offset if applicable, +/−166 kHz

Each row of this LUT relates to a respective channel number which is occupied and indicates whether the signal is analogue or digital, the power level of the signal in the channel, the signal/noise ratio for the digital signals, and any offset which is applicable. In addition, each row contains information about potential adjacent channel “interferers”. This information comprises the presence mid type (analogae or digital) and power level of the lower or upper adjacent channel.

During the normal reception mode of the tuner, the LUT 18 is used to adapt the tuner for reception of the selected channel. In particular, when a channel selection is made, for example by a user using a remote control to signal the selected channel to the controller 8, the controller 8 determines whether the lower and/or upper adjacent channel is occupied and, if so, determines the corresponding power level. This is used to supply a gain control signal to the stage 4 for setting the front end gain in accordance with the prevailing reception conditions. Also, the threshold level of the AGC arrangement of the stage 10 is set or adapted to the prevailing reception conditions. For example, in the presence of a strong adjacent channel interferer, the gain of the stage 4 may be set to a relatively low value so as to avoid overloading the input of the mixer 5. Similarly, the target AGC level is set by measuring the bit error rate (BER) and slowly adjusting the AGC target until the lowest BER is achieved.

In accordance with a first modification, the output of the ADC 16 (or the detector 15 if analog/digital conversion is not required) may be supplied to the demodulator 20. The demodulator 20 then controls the AGC with the AGC target level being set by the controller 8.

In accordance with a second alternative or additional modification, the output of the detector 13 may be supplied directly to the gain control input of the stage 4 so that the ADC 14 and the DAC 17 may be omitted. In this arrangement, the controller 8 does not control the gain of the stage 4.

It is thus possible to provide a tuner which has “prior knowledge” of the location and power level of interferers so that it may adapt its level control circuitry to allow or compensate for them. By using “software mapping” techniques to build and/or update a map of the channels present at the tuner input, it is possible to use this data, for example by a combination of analogue and digital techniques, to enhance the ability of the tuner to maintain a good signal/noise ratio in the presence of analogue and/or digital interferers Overload and/or distortion can be avoided or reduced to permit acceptable reception to be obtained in a very wide variety of circumstances. Adjacent channel interference may be avoided or reduced.

What is claimed is:

1. A tuner for selecting a channel for reception from a multiple channel input signal, said tuner comprising: a signal path arranged to select a channel and to convert said selected channel to a format suitable for demodulation, said signal path including at least one controllable variable gain stage; and a controller having a reception mode and a channel napping mode, said controller being arranged, in said mapping mode, to provide a look-up table of channel occupancy in said input signal and, in said reception mode, to control a gain of said at least one variable gain stage in accordance with said occupancy, from said table, of at least one channel adjacent said selected channel

2. A tuner as claimed in claim 1, in which said tuner is arranged, in said mapping mode, to create and update said table from said input signal.

3. A tuner as claimed in claim 1, in which said controller is arranged to perform said mapping mode each time said tuner is powered up.

4. A tuner as claimed in claim 1, in which said controller is arranged to perform said mapping mode during a stand-by mode of said tuner.

5. A tuner as claimed in claim 1, in which said controller is arranged to perform said mapping mode periodically while said tuner is powered up.

6. A tuner as claimed in claim 1, in which said table comprises a plurality of entries, each of which relates to a respective channel.

7. A tuner as claimed claim 6, in which each entry comprises a number of said respective channel and an indication of whether said respective channel is occupied by a signal.

8. A tuner as claimed in claim 7, in which said entry in said table for each occupied channel contains an indication of whether said signal is analog or digital.

9. A tuner as claimed in claim 1, in which said entry in said table for each occupied channel contains an indication of a signal power.

10. A tuner as claimed in claim 1, in which said entry in said table for each occupied channel contains an indication of a signal/noise ratio.

11. A tuner as claimed in claim 1, in which each said entry in said table contains an indication of any frequency offset from a nominal channel frequency.

12. A tuner as claimed in claim 1, in which said entry in said table for each occupied channel contains an indication of whether at least one of an adjacent higher channel and an adjacent lower channel is occupied.

13. A tuner as claimed in claim 12, in which said entry in said table for each occupied channel with at least one said occupied adjacent channel contains at least part of an entry for said at least one occupied adjacent channel.

14. A tuner as claimed in claim 1, in which said signal path comprises at least one frequency changer for converting said selected channel to an intermediate frequency.

15. A tuner as claimed in claim 14, in which said at least one variable gain stage comprises a first variable gain stage ahead of said at least one frequency changer.

16. A tuner as claimed in claim 15, in which said controller is arranged to reduce a gain of said first variable gain stage when said at least one adjacent channel is occupied.

17. A tuner as claimed in claim 13, in which said at least one variable gain stage comprises a second intermediate frequency variable gain stage forming part of an automatic gain control arrangement.

18. A tuner as claimed in claim 17, in which said controller is arranged to reduce a target level of said automatic gain control arrangement when said at least one adjacent channel is occupied.

19. A tuner as claimed in claim 1, in which said controller is arranged, in said mapping mode, to scan said tuner through said channels in said input signal and to determine said channel occupancy on a basis of received signal level.

20. A tuner as claimed in claim 1, in which said controller is arranged, in said mapping mode, to scan said tuner through said channels in said input signal and to determine said channel occupancy by a digital signal on a basis of a presence of TPS (transmission parameter signalling) data.
